(19) United States
(12) Patent Application Publication
(10) Pub. No.: US 2017/0051856 A1
(43) Pub. Date: Feb. 23, 2017

(54) PIPE CONNECTOR FOR CONNECTING A FUEL LINE OF A FUEL SUPPLY FOR A MOTOR VEHICLE ENGINE

(71) Applicants: Dr. Ing. h.c. F. Porsche Aktiengesellschaft, Stuttgart (DE); Magna Steyr Fuel Systems GesmbH, Sinabelkirchen (AT)

(72) Inventors: Armin Krezer, Obersulm (DE); Kai Podewski, Pforzheim (DE); Bernhard Gschanes, Gleisdorf (AT); Michael Schinnerl, St. Radegund (AT)

(21) Appl. No.: 15/237,659

(22) Filed: Aug. 16, 2016

(30) Foreign Application Priority Data
Aug. 21, 2015 (DE) 10 2015 113 896.4

(51) Int. Cl. F16L 25/01; F16L 33/22

(52) U.S. Cl. CPC F16L 25/01; F16L 33/22

(57) ABSTRACT

A pipe connector for connecting a fuel line of a fuel supply for a motor vehicle engine of a motor vehicle includes an adapter piece that is connectable to the fuel line for insertion into a fuel pipe. A supporting sleeve is inserted into the adapter piece such that the supporting sleeve is configured to make electrical contact between the fuel line and the fuel pipe. The supporting sleeve has, in a subregion, a stop tab which extends out of a lateral surface plane of the supporting sleeve so as to make axial stop contact with the adapter piece.

### CROSS-REFERENCE TO PRIOR APPLICATION

Priority is claimed to German Patent Application No. DE 10 2015 113 896.4, filed on Aug. 21, 2015, the entire disclosure of which is hereby incorporated by reference herein.

### FIELD

The invention relates to a pipe connector, with the aid of which a fuel line as part of a fuel supply can be connected to a motor vehicle engine of a motor vehicle.

### BACKGROUND

EP 2 799 273 A1 discloses a tank system in which a filler pipe is connected to a filler hose by inserting a cylindrical supporting sleeve produced from an electrically conductive plastics material into the filler pipe, the depth of insertion of said sleeve being limited by a supporting rib projecting radially outward from the outer lateral surface of the cylindrical supporting sleeve. In addition, tabs project from the outer lateral surface of the cylindrical supporting sleeve, said tabs resting radially from the inside on the filler hose outside the filler pipe. That part of the supporting sleeve which is inserted into the filler pipe is shaped so as to be purely cylindrical.

### SUMMARY

In an embodiment, the present invention provides a pipe connector for connecting a fuel line of a fuel supply for a motor vehicle engine of a motor vehicle. The pipe connector includes an adapter piece that is connectable to the fuel line for insertion into a fuel pipe. A supporting sleeve is inserted into the adapter piece so as to make electrical contact between the fuel line and the fuel pipe. The supporting sleeve has, in a subregion, a stop tab which extends out of a lateral surface plane of the supporting sleeve so as to make axial stop contact with the adapter piece.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic plan view of part of a pipe connector and

FIG. 2 is a schematic sectional view of a pipe connection system having a pipe connector from FIG. 1.

### DETAILED DESCRIPTION

It is advantageous to be able to connect a fuel line for a motor vehicle engine as inexpensively as possible.

In an embodiment, the present invention provides measures which enable a fuel line for a motor vehicle engine to be connected at low cost.

According to an embodiment of the invention, a pipe connector for connecting a fuel line of a fuel supply for a motor vehicle engine of a motor vehicle is provided, having an adapter piece, which can be connected to the fuel line, for insertion into a fuel pipe, and a supporting sleeve, which is inserted into the adapter piece, for making electrical contact between the fuel line and the fuel pipe, wherein the supporting sleeve has, in a subregion, a stop tab, which extends out of a lateral surface plane of the supporting sleeve, for making axial stop contact with the adapter piece.

The supporting sleeve can support the adapter piece radially from the inside when the adapter piece is connected to the fuel pipe. By way of example, the adapter piece can be produced from a plastics material which could otherwise yield radially inward if the adapter piece were fastened to the fuel pipe and/or secured against slipping off by means of a clamping ring, a retention clip of a tightened union nut or some other fastening means that exerts a clamping force radially from the outside on the adapter piece. The supporting sleeve can thereby ensure a reliable and leaktight connection of the adapter piece to the fuel pipe.

In particular, the supporting sleeve can project through the adapter piece and protrude from the adapter piece at the axial ends of the adapter piece. This enables the supporting sleeve to rest by means of a first end on the fuel line and by means of a second end on the fuel pipe in the assembled state. The supporting sleeve can be sufficiently electrically conductive to dissipate an electrostatic charge on the fuel line and the fuel pipe due to the fuel flowing through and to prevent electrostatic ignition of gaseous fuel. For this purpose, the supporting sleeve can be produced from a metallic material, e.g. a steel sheet, for example. It is also possible to accomplish electrical contacting of the adapter piece at least via the stop tab striking against the end face of the adapter piece in order to avoid electrostatic charging of the adapter piece. This makes it possible for the adapter piece to interact with the fuel line and/or with the fuel pipe without adequate electrically conductive contact since the electrical contact can be made via the supporting sleeve. This allows additional degrees of design freedom in the configuration of the attachment of the adapter piece to the fuel line and the fuel pipe, making possible a low-cost design. For example, the adapter piece could engage on the fuel pipe exclusively via electrically nonconductive sealing elements, thus making it possible to eliminate design measures for making direct electrical contact between the adapter piece and the fuel pipe.

By means of the stop tab striking against the end face of the adapter piece, the depth of insertion of the supporting sleeve into the adapter piece can be precisely predetermined. In particular, it is thereby possible precisely to predetermine how far the supporting sleeve projects from the adapter piece in the axial direction, thus ensuring reliable contacting of the fuel line and the fuel pipe. To form the stop tab, the stop tab is configured so as to extend radially outward from the material of the supporting sleeve, the basic shape of which is, in particular, substantially cylindrical. This means that the material of the supporting sleeve which otherwise forms the lateral surface is used in a subregion of the substantially cylindrical supporting sleeve to form the stop tab and projects radially outward instead to such an extent that the stop tab thus formed strikes against an axial end face of the adapter piece when the supporting sleeve is inserted into the adapter piece. Accumulation of material on the supporting sleeve, as would be the case with an integrally formed rib for example, is thereby avoided, thus enabling the supporting sleeve to be formed with a lower input of material, thereby allowing production costs to be reduced. In particular, it is possible to produce the supporting sleeve at low cost from flat stock, e.g. a metal sheet, and, in the process, to partially punch out the stop tab from the material of the supporting sleeve and then bend it out of the lateral surface plane of the supporting sleeve. By means of the stop tab extending out of the lateral surface plane, it is possible to predetermine the depth of insertion of the cheap-to-produce supporting sleeve into the adapter piece without an additional accumulation of material and with little assembly effort, thus making possible low-cost connection of a fuel line for a motor vehicle engine.

The lateral surface plane of the supporting sleeve is defined by the circumferentially extending lateral surface of the substantially cylindrical part of the supporting sleeve, said part being covered in a radial direction by the adapter piece radially within the adapter piece. The stop tab extending out of the lateral surface plane leaves behind a depression or opening corresponding to the stop tab in the wall thickness of the supporting sleeve, a depression or opening which could be at least to a large extent filled by the stop tab if the stop tab could be moved into this depression or opening. In particular, the stop tab can be pressed into the lateral surface plane of the supporting sleeve radially from the outside counter to a spring force applied by the stop tab. The stop tab can thereby act as a snap lock, which can be inserted into the adapter piece in a first axial direction and can then block a movement of the supporting sleeve counter to the first axial direction by positive engagement after an upward, radially outward rebound movement due to the spring force. With the aid of the stop tab, a safeguard against loss can thereby be formed. It is also possible to insert the supporting sleeve into the adapter piece in a second axial direction counter to the first axial direction until the stop tab strikes positively against the adapter piece and blocks a further movement of the supporting sleeve relative to the adapter piece in the second axial direction.

In particular, the supporting sleeve has a substantially constant wall thickness. As a result, the supporting sleeve can easily be produced from low-cost flat stock, which can, in particular, be made available as endless stock. Unnecessary accumulations of material, for the production of which an injection molding process with a correspondingly expensive negative mold is required for example, can thereby be avoided.

The stop tab is preferably bent out of the lateral surface plane of the supporting sleeve. This enables the stop tab to be produced at low cost by punching the stop tab partially out of the material of the lateral surface plane of the supporting sleeve and bending it out of the lateral surface plane by a subsequent plastic deformation.

As a particularly preferred option, the stop tab rests on an end face of the adapter piece facing away from the fuel line, wherein the stop tab is connected to the rest of the supporting sleeve outside the adapter piece in an axial direction, in particular within the fuel pipe. As a result, the stop tab is self-energizing. When the stop tab is pressed against the end face of the adapter piece with an increased force, the stop tab will merely rise further and, as a result, will produce an even stronger resistance.

In particular, the supporting sleeve has, in a subregion, a counter stop tab for making axial stop contact with the adapter piece in an opposite direction from the stop tab and/or for applying a radial clamping force to an inner side of the adapter piece, said counter stop tab extending out of a lateral surface plane of the supporting sleeve. The counter stop tab can provide a positive and/or frictional resistance to a relative movement of the supporting sleeve in the adapter piece in one direction which is not blocked by the stop tab. For example, the counter stop tab can be part of a latching connection similar to a cable tie, thereby allowing the supporting sleeve to be inserted into the adapter piece in a defined relative position so as to be secure against loss. The counter stop can be of similar, in particular mirror-image, design to the stop tab.

The counter stop tab preferably engages on the adapter piece radially within the adapter piece. For example, the counter stop tab can snap into a depression, e.g. an annular groove running around in the circumferential direction, within the adapter piece. Since the counter stop tab does not thereby rest on the end face of the adapter piece facing the fuel line, it is possible to use this end face for some other purpose, in particular for fastening to the fuel line.

As a particularly preferred option, the stop tab and/or the counter stop tab is/are inserted into a corresponding receiving pocket of the adapter piece to form an anti-twist device. The receiving pocket can also form stops acting in the circumferential direction, with the result that a relative rotation of the supporting sleeve in the adapter sleeve is also blocked by positive engagement.

In particular, the supporting sleeve is produced from a metallic material, in particular a metal sheet. As a result, the supporting sleeve has good electrical conductivity. Moreover, the stop tab can be produced easily and at low cost by punching and plastic forming.

The supporting sleeve preferably has at least one first spring leg for making resilient contact with the fuel line radially from the inside and/or at least one second spring leg for making resilient contact with the fuel pipe radially from the inside, wherein, to form the first spring leg, the supporting sleeve has first slots extending in an axial direction at its first end facing toward the fuel line, and/or, to form the second spring leg, the supporting sleeve has second slots extending in an axial direction at its second end facing toward the fuel pipe. The spring leg can rest radially from the inside, with a spring force, on the inner side of the fuel line or the fuel pipe and thereby ensure electrical contact. In particular, the spring leg bulges radially outward at its protruding end, giving an introduction chamfer which facilitates the insertion of the spring leg into the fuel line or the fuel pipe. Moreover, the rounded profile of the bulging region of the spring leg also enables electrical contact to be established in the case of alignment tolerances.

As a particularly preferred option, the adapter piece is welded to the fuel line, in particular indirectly via a welding ring produced from a plastics material, wherein the fuel line and the adapter piece have a plastics material. The welding ring can be produced from polyethylene, in particular HDPE, for example. The adapter piece can be produced from glass fiber reinforced polyamide, for example. The fuel line can be produced from a plastic, e.g. PE. It is possible to weld the adapter piece with the inserted supporting sleeve to the fuel line or to insert the supporting sleeve only after welding. By virtue of the fact that the adapter piece is connected as a separate part to the fuel line, the adapter piece can be used as a common part at different points in the fuel supply of the motor vehicle and/or can be used for different fuel lines of different motor vehicle models. It is thereby possible to keep down production costs.

The invention furthermore relates to a pipe connection system for supplying fuel to a motor vehicle engine, having a pipe connector, which can be embodied and developed as described above, and having a fuel pipe produced from a metallic material, wherein the adapter piece is inserted into the fuel pipe. By means of the stop tab of the supporting sleeve of the pipe connector, which tab extends out of the lateral surface plane, it is possible to predetermine the depth of insertion of the cheap-to-produce supporting sleeve into the adapter piece without an additional accumulation of material and with little assembly effort, thus making possible low-cost connection of a fuel line for a motor vehicle engine.

The invention is explained by way of example below by means of preferred illustrative embodiments with reference to the attached drawings, wherein the features described above and below can each represent an aspect of the invention, either individually or in combination.

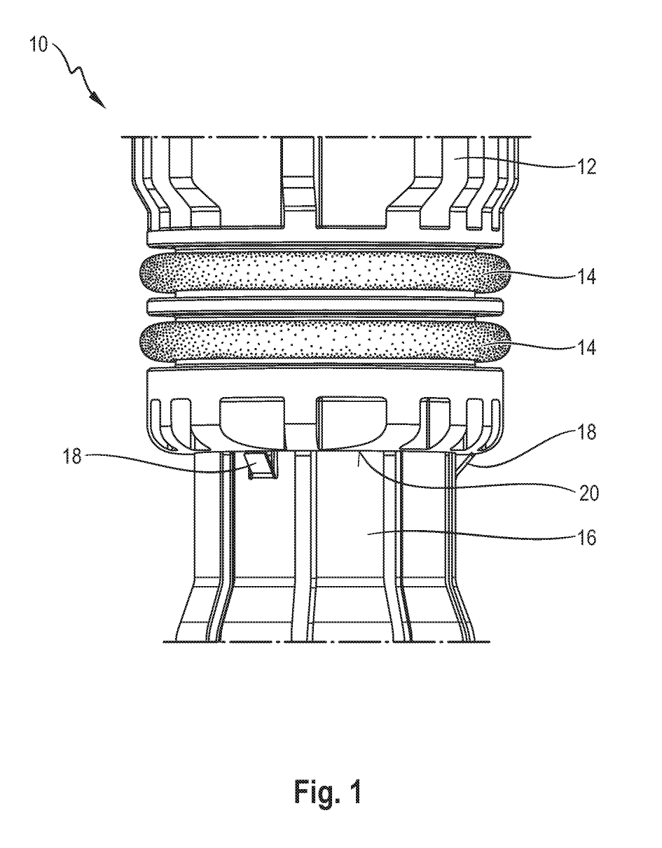

The pipe connector 10 illustrated in FIG. 1 has an adapter piece 12, into which two sealing rings 14 are recessed, for example. A supporting sleeve 16 is inserted into the adapter piece 12. Stop tabs 18 are bent out of a lateral surface plane of the supporting sleeve 16, said tabs striking against an end face 20 of the adapter piece 12. In the illustrative embodiment shown, the end face 20 coincides with an axial end of the adapter piece 12. It is also possible for the stop tabs 18 to engage in corresponding receiving pockets of the adapter piece 12 in order additionally to form an anti-twist device. The stop tabs 18 are connected outside the adapter piece 12 to the rest of the supporting sleeve 16, which is produced from a metal sheet, thus making it possible reliably to avoid insertion of the supporting sleeve 16 further into the adapter piece 12.

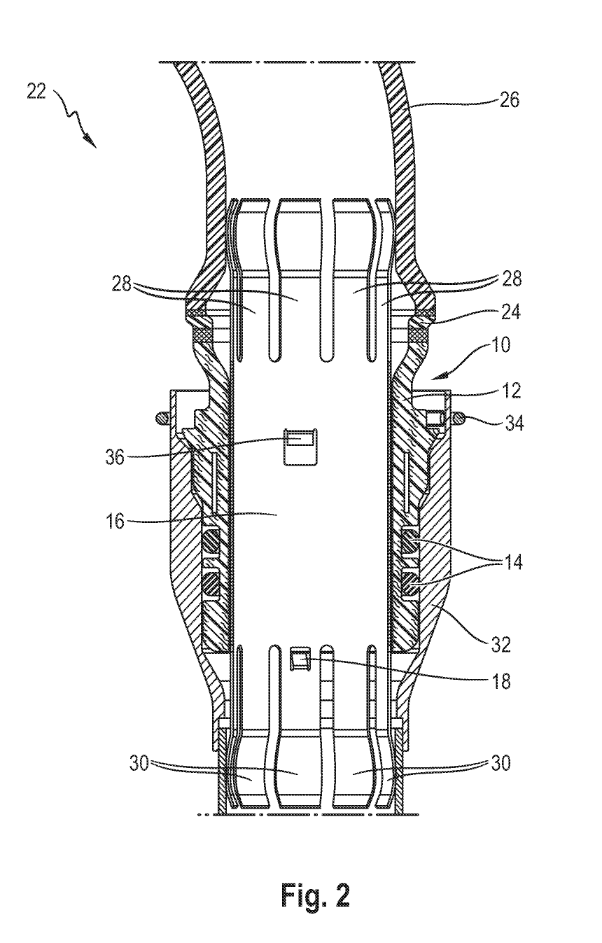

As illustrated in the pipe connection system 22 shown in FIG. 2, the adapter piece 12 can be welded to a plastic fuel line 26 by way of a welding ring 24. The supporting sleeve 16 has first spring legs 28, which are separated from one another in the circumferential direction by axially extending slots, which rest radially from the inside, with a spring force, on an inner side of the fuel line 26 and which produce electrical contact. In a corresponding manner, the supporting sleeve 16 has, at its other end, second spring legs 30, which are separated from one another in the circumferential direction by axially extending slots, which rest radially from the inside, with a spring force, on an inner side of a fuel pipe 32 and which produce electrical contact.

The adapter piece 12 is inserted into the fuel pipe 32, to which the fuel line 26 is to be connected by means of the pipe connector 10. The adapter piece is sealed off with respect to the fuel pipe 32 by means of the sealing rings 14. With the aid of a retention clip 34, the fuel pipe 32 is pressed into contact with the adapter piece 12, ensuring that the pipe connector 10 does not unintentionally slip out of the fuel pipe 32, even in the case of an increased internal pressure during the delivery of fuel.

In particular, the respective stop tab 18 is bent out of an associated second spring leg 30. In addition, a counter stop tab 36 is preferably bent out of the lateral surface plane of the supporting sleeve 16. The counter stop tab 36 projects radially outward within the adapter piece 12 and can interact nonpositively and/or positively with the adapter piece 12, thus making it possible to block both axial directions of movement of the supporting sleeve 16 relative to the adapter piece by means of the stop tab and the counter stop tab 36.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A pipe connector for connecting a fuel line of a fuel supply for a motor vehicle engine of a motor vehicle, the pipe connector comprising:
an adapter piece that is connectable to the fuel line for insertion into a fuel pipe, and
a supporting sleeve which is inserted into the adapter piece so as to make electrical contact between the fuel line and the fuel pipe, the supporting sleeve having, in a subregion, a stop tab which extends out of a lateral surface plane of the supporting sleeve so as to make axial stop contact with the adapter piece.

2. The pipe connector as claimed in claim 1, wherein the supporting sleeve has a substantially constant wall thickness.

3. The pipe connector as claimed in claim 1, wherein the stop tab is bent out of the lateral surface plane of the supporting sleeve.

4. The pipe connector as claimed in claim 1, wherein the stop tab rests on an end face of the adapter piece facing away from the fuel line, wherein the stop tab is connected to the rest of the supporting sleeve outside the adapter piece in an axial direction.

5. The pipe connector as claimed in claim 1, wherein the supporting sleeve (16) has, in a subregion, a counter stop tab configured to make axial stop contact with the adapter piece in an opposite direction from the stop tab and/or configured to apply a radial clamping force to an inner side of the adapter piece, the counter stop tab extending out of a lateral surface plane of the supporting sleeve.

6. The pipe connector as claimed in claim 5, wherein the counter stop tab engages on the adapter piece radially within the adapter piece.

7. The pipe connector as claimed in claim 1, wherein at least one of the stop tab or a counter stop tab is inserted into a corresponding receiving pocket of the adapter piece so as to form an anti-twist device.

8. The pipe connector as claimed in claim 1, wherein the supporting sleeve is produced from a metallic material.

9. The pipe connector as claimed in claim 1, wherein the supporting sleeve has at least one first spring leg configured to make resilient contact with the fuel line radially from the inside and/or at least one second spring leg configured to make resilient contact with the fuel pipe radially from the inside, and wherein the first spring leg is formed by the supporting sleeve having first slots extending in an axial direction at a first end thereof facing toward the fuel line and/or the second spring leg is formed by the supporting sleeve having second slots extending in the axial direction at a second end thereof facing toward the fuel pipe.

10. The pipe connector as claimed in claim 1, wherein the adapter piece is welded to the fuel line, and wherein the fuel line and the adapter piece have a plastics material.

11. The pipe connector as claimed in claim 10, wherein the adapter piece is welded to the fuel line indirectly via a welding ring produced from a plastics material.

12. The pipe connector as claimed in claim 4, wherein the stop tab is configured to be disposed within the fuel pipe.

13. The pipe connector as claimed in claim 8, wherein the supporting sleeve is produced from a metal sheet.
